(19) United States
(12) Patent Application Publication
(10) Pub. No.: US 2004/0122721 A1
(43) Pub. Date: Jun. 24, 2004

(54) Calendar travel time module

(76) Inventor: Peter M. Lasorsa, Bartonville, IL (US)

Correspondence Address: CATERPILLAR INC., 100 N.E. ADAMS STREET, PATENT DEPT., PEORIA, IL, 616296490

(21) Appl. No.: 10/323,584

(22) Filed: Dec. 18, 2002

(51) Int. Cl. G06F 17/60

(52) U.S. Cl. 705/8

(57) ABSTRACT

A method of scheduling at least one time buffer associated with a calendar entry for at least one user in a networked environment. The method includes, prompting the user to enter a time value associated with at least one time buffer, entering the time value into at least one time buffer and updating the users calendar with at least one entry in response to the scheduled time buffer.

### TECHNICAL FIELD

The present invention relates generally to a method of scheduling a time buffer and more particularly with a method of scheduling a time buffer associated with a calendar entry for at least one user in a networked environment.

### BACKGROUND

Currently, a user schedules appointments, meetings and scheduling actions using a number of different software packages, available on the market, such as Lotus Notes™, and Microsoft Outlook™. The user may also accept appointments, meetings, and scheduling actions sent by other users. The above referenced calendaring systems allow for a convenient and organized method of keeping track of ones schedule.

Presently, if a user wants to schedule a meeting with two other people from 9:00-10:00 in conference room C, the user would open his calendar, select “schedule meeting”, enter the time, from either a pull down menu, manual entry or scrolling clock, and pick the two other users that were to be invited. Next, the user would click save or send. The software program would make an entry into the users calendar from 9:00-10:00. Additionally, the software program would send an invitation to the two users inviting them to attend the meeting. The users calendaring system could either automatically accept or decline the invitation and update their calendars (if accepted) or the calendaring system could prompt the users to manually accept or decline the invitation (Updating the users calendar if accepted). The same procedure would be utilized for a scheduling action or appointment.

However, the calendaring systems do not take into consideration a “time buffer” associated with the calendar entry. For example, the user may need 15 minutes before the meeting to review documents, get a cup of coffee, make a phone call, or travel to the meeting place. Additionally, the user may require a “time buffer” on the other end of the meeting, for the same reasons.

The current calendaring programs require the user to manually enter a separate entry before the scheduling action, and a second separate entry after the scheduling action, to accommodate “time buffers” before and after the scheduling action. This requires three entries into the calendaring system, which requires the user to remember to make the additional entries.

For example, a user receives an invitation for a meeting, from 9:00-10:00, from someone in an office that is located 20 minutes away. Without giving much thought at the time to the location, the user accepts the invitation and the software program adds the entry to the users calendar. This creates several problems. First, the users calendar shows them free from 8:00-9:00 and from 10:00-11:00, when in fact, the user must leave his office at 8:40 to arrive at the meeting on time, since the meeting is 20 minutes away. Additionally, the user will not return to his office until 10:20 because the meeting was 20 minutes away, yet his calendar shows him available at 10:00. This causes the users calendar to be inaccurate, which affects other users who schedule-scheduling actions based on the users availability, based on the users calendar.

Secondly, the user may not be aware the meeting is 20 minutes away until it is too late, causing him to be late for the meeting. For example, the user arrives to work in the morning at 8:00 and checks his calendar; his first meeting is at 9 o'clock. He starts working, around 8:45 he decides to start preparing for the meeting; he gets his notebook, clicks on his calendar entry to find the location and realizes the meeting is 20 minutes away. He arrives 5 minutes late to the meeting.

An alterative system explained in U.S. Pat. No. 6,101,480, creates and stores profiles associated with a user. The above referenced system may take the invitee's time zone and work location into consideration if the scheduling action is to take place at a location remote from the invitee's work location. For example, if the scheduling action location provides resources, which permit participation by remote means, and in-person attendance is not required, then a person working in that location may be treated as available for a proposed scheduling action occurring at another location and/or time zone.

Additionally, if the invitee is in a different time zone or place, and plans on physically attending the proposed scheduling action, the user coordinator of the scheduling action is prompted to decide whether to make adjustments to ensure the availability of that invitee. The prompting may be done through the use of an additional dialog box that requests further clarification on how an invitee who is in a different time zone or location should have its free time treated for purposes of analyzing availability. The user proposing the scheduling action may have to make certain decisions, such as whether the invitee's work schedule should be honored, and conferencing by remote means therefore used, or whether the invitee's work schedule should be disregarded, and physical attendance therefore requested or ordered. An embodiment of U.S. Pat. No. 6,101,480 also allows coordinators or users to change work hours, time zone, and place of work from a default setting to conform to information on a set travel itinerary.

The problem with the above referenced system described in U.S. Pat. No. 6,101,480 is the following. First, the referenced system creates and stores profiles. A stored profile can never truly know how much time the user needs or wants before and after a meeting. The stored profile makes automatic assumptions about a persons needs and bases an action on those needs. For example, Bob may be located in building A and gets invited to building B. The two buildings are 30 minutes away from each other by automobile. Under the above referenced system, 30 minutes will be automatically added to Bobs calendar to allow for travel time, based on his profile and the location of the other building. However, there is a broken water main that will require the main road to be shut down for several days. The profile does not take this into consideration; therefore the actual travel time from building A to building B is one hour. The above referenced system does not solve the problem of allowing user configured adequate travel time.

Secondly, Bob may be located on the 6^{th} floor of building A and Jim may be located on the 6^{th} floor of building A. The above referenced system would store both Bob's and Jim's locations in their profile and adjust their calendar based on the 6^{th} floor location. If Jim sent Bob an invitation to come to Jim's office for a meeting, the above referenced system would put no time before or after Bob's calendar for travel time since they are both located on the same floor, in the same building. However, if the location stored in the profile has such detail that each individual office, on each floor, determines the location in each building, then the entry into Bob's calendar would be fractions of a minute. (the time to walk from Bob's office to Jims, which is two offices away). Therefore under the above referenced system, at best, Bob would have a fraction of a minute added to his calendar for travel time. The problem, however, is that Bob really needs 30 minutes before the meeting to review his notes and make a phone call. Bob also wants 30 minutes after the meeting to make two phone calls to discuss the meeting he just had with Jim. Under the present system, Bob would have to make a second entry to review his notes, make a phone call, and a third entry to make two phone calls to discuss what the meeting with Jim was about. The invention described in U.S. Pat. No. 6,101,480 does not overcome the problem and allow 30 minutes prior to the meeting with Jim and 30 minutes after the meeting with Jim.

Using current systems, a user would have to make three separate entries in the calendaring program, which is time consuming to address scheduling issues. However, if the calendaring program is set-up to automatically accept invitations, the chances of forgetting to make two additional entries for each accepted invitation increase, because the computer program is processing the invitations surreptitiously.

The present invention is directed to overcoming one or more of the problems set forth above.

### SUMMARY OF THE INVENTION

In one aspect of the present invention a computer-implemented method of scheduling a time buffer associated with a calendar entry for at least one user in a networked environment is disclosed. The method includes the steps of displaying at least one dialog box in response to scheduling at least one scheduling action, prompting the user to enter a time value associated with at least one time buffer, entering a time value into at least one time buffer and updating the users calendar with at least one entry in response to the scheduled time buffer.

In another aspect of the present invention, a computer program product for scheduling at least one time buffer associated with a calendar entry for at least one user in a networked environment is disclosed. The computer program product includes, a first computer readable program means for displaying at least one dialog box in response to a scheduling action the dialog box, prompting the user to enter a time value associated with at least one of the time buffer. A second computer readable program means for receiving the time value from the user, and a third computer readable program means for updating the user's calendar in response to the received time value.

### BRIEF DESCRIPTION OF THE DRAWINGS

FIG. 1 is a flow chart of the steps involved in prompting a user to enter a time value associated with a scheduling action;

FIG. 2A is one embodiment of an invitation dialog box;

FIG. 2B is a screen shot of one method of entering a time value associated with a scheduling action by utilizing a time value;

FIG. 3 is an illustration of a computer program product associated with the present invention;

FIG. 4 is a screen shot of one method of entering a time value associated with a scheduling action by utilizing a time value;

FIG. 5 is a screen shot of an alternative method of entering a time value associated with a scheduling action by manually entering the time;

FIG. 6 is a screen shot of an alternative method of entering a time value associated with a scheduling action by utilizing a button box pull down menu; and

FIG. 7 is a screen shot of an alternative method of entering a time value associated with a scheduling action by utilizing a keypad.

### DETAILED DESCRIPTION

The present disclosure is associated with a computer-implemented calendaring system and method of scheduling a time value associated with a scheduling action.

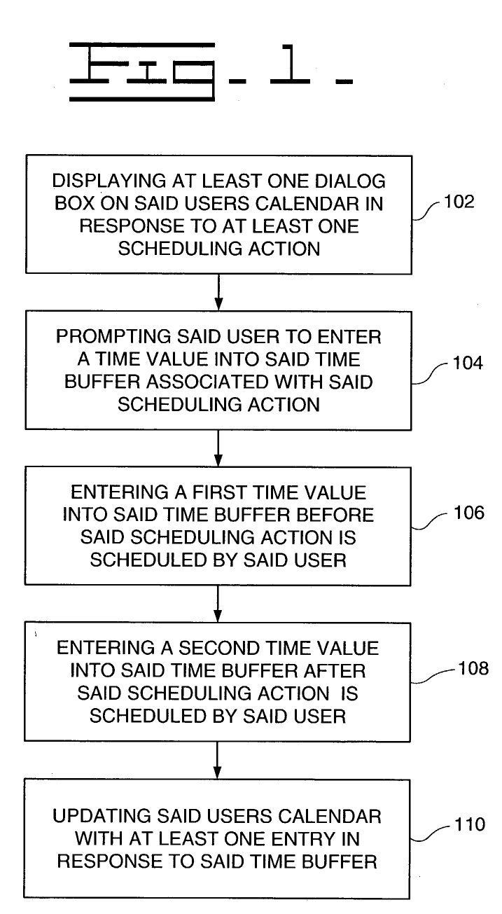

FIG. 1 illustrates one embodiment of a method of scheduling at least one time buffer associated with a calendar entry for at least one user, in a networked environment. For example, an event to be scheduled may have a time buffer before the event, and a time buffer after the event, which may be scheduled. In a first control block 102, at least one dialog box is displayed in response to a scheduling action. A scheduling action is an action associated with the scheduling of an event, such as a meeting. For example, the scheduling action may be the user initiating a meeting, or by acceptance of a meeting invitation, either automatically or manually. In response to the acceptance of a meeting invitation automatically, manually, or by a user initiating a meeting, a dialog box may be displayed to the user. In a second control block 104, the user is prompted via a dialog box, to enter a time value into at least one time buffer associated with the event to be scheduled. In a third control block 106, the user enters a time value into the time buffer before the event. Next, the user enters a time value into the time buffer after the scheduling action. In one embodiment, time for the time buffer may be zero (i.e. no time buffer desired) therefore, if the user doesn't enter a time value, zero time will be put into the buffer. In a fourth control block 108, the users calendar is updated with at least one entry in response to the time buffers. For example, a user comes to work and logs into the network. The user “Bob” may open his calendar through a software program, such as Lotus Notes.™ An employee in another department sends Bob an invitation to a meeting that is planned for 10:00 in conference room 1000 on the 10^{th} floor. The meeting is planned for an hour and the meeting is in reference to a new employee retirement plan the company is rolling-out. Bob's calendar will display at least one dialog box in response to the scheduling action (i.e. the receipt of the invention for the planned meeting). Bob may accept the planned meeting manually, at which time the dialog box is displayed, or the planned meeting may be automatically accepted, in which case no dialog box is displayed until Bob manually clicks on the calendar entry for the planned meeting (which has been automatically accepted).

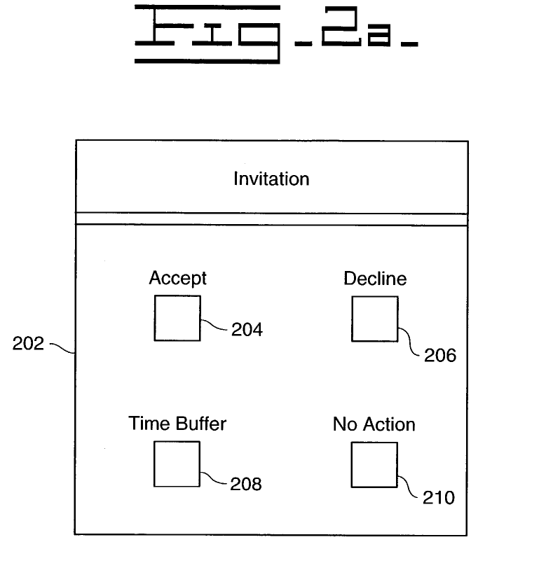

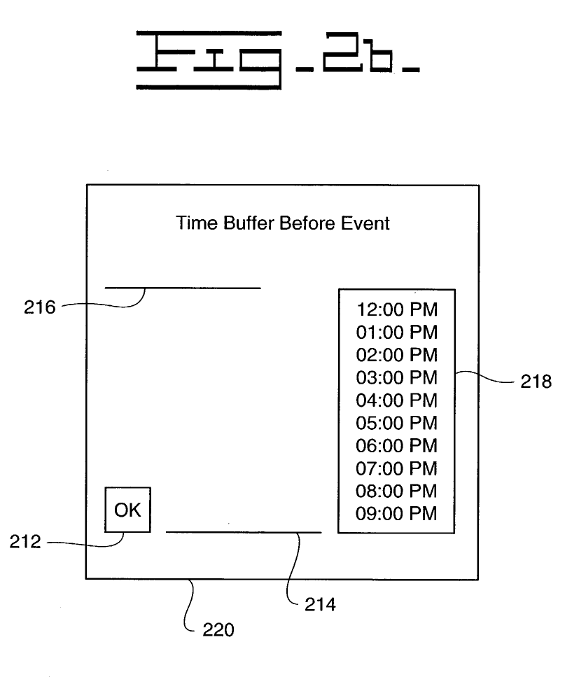

FIG. 2A illustrates one embodiment of an invitation dialog box 202 in which a time buffer button 208 may be incorporated on the invitation dialog box 202. The invitation dialog box 202 may be displayed when an invitation is sent or received. The invitation dialog box 202 may have multiple buttons the user may click to initiate some action. For example, the invitation dialog box 202 may have an “accept” button 204, a “decline” button 206, a “no action” button 210 and a button labeled “time buffer” 208. The user, to accept or decline the invitation may click the accept/decline buttons 204 and 206 respectively. If the user clicked the “time buffer” button 208, at least one dialog box 220, would appear on the users screen, as illustrated in FIG. 2B. The user may enter a time buffer in at least one dialog box 220. For example, Bob may get an invitation from Jim and the invitation may have several buttons incorporated on the invitation or the display associated with the invitation. (i.e. when the invitation is viewed, there may be several buttons displayed.) One button would be to accept the invitation 204, another would be to decline the invitation 206, another would be to take no action 210 and another would have the words “time buffer” 208 on it. If Bob clicked the “time buffer” button 208, at least one dialog box 220, would appear and Bob could enter time in this box using the scrolling time device 218. The time selected using the scrolling time device 218 would appear in the box where time is displayed 216. Bob may also type a reason for the time buffer in text data field 214 and click the ok button 212 when finished.

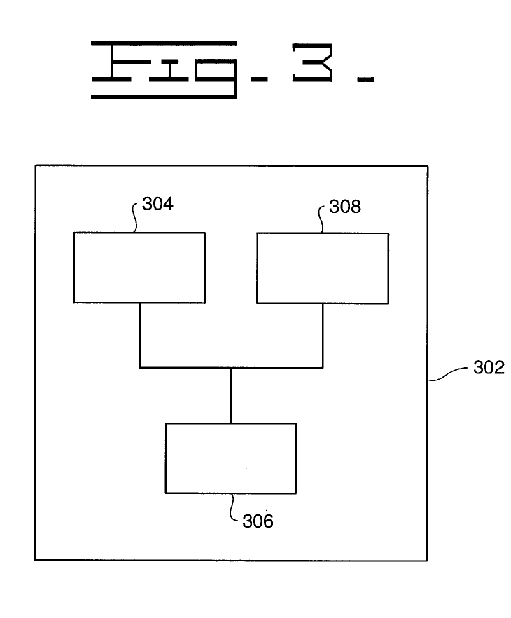

FIG. 3 illustrates one embodiment of a computer program product 302 associated with the present invention. The computer program product schedules at least one time buffer associated with a calendar entry for at least one user in a networked environment. The computer program product 302 is comprised of a first computer readable program means 304 for displaying at least one dialogue box in response to a scheduling action. A dialogue box prompts the user to enter a time value associated with at least one time buffer. Additionally, a second computer readable program means 304 receives the time value from a user. A third computer readable program means 308, updates the user's calendar in response to the received time value.

### Industrial Applicability

The present disclosure includes a method of scheduling a time buffer associated with a calendar entry for at least one user in a networked environment.

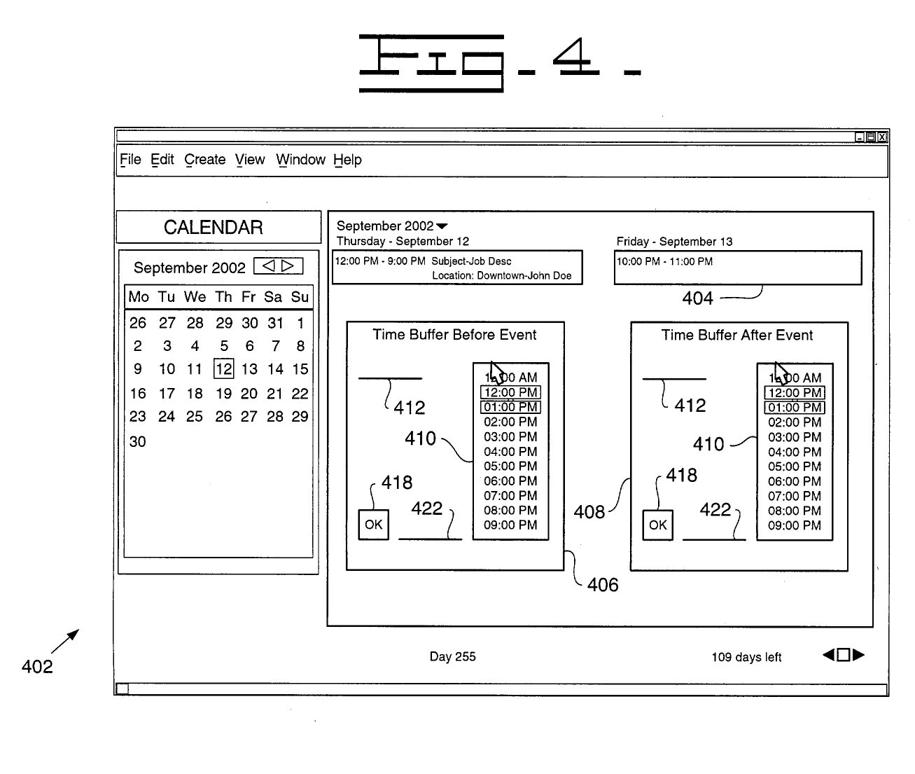

FIG. 4 is a screen shot illustrating one embodiment of scheduling a time buffer associated with a calendar entry 404. In FIG. 4, Bob's calendar 402 is displayed and the invitation to the 10 o'clock meeting, dialog box 404 is displayed. If the user was not in work that day and the invitation dialog box 404 was processed automatically, display boxes 406 and 408 would appear the next time the user opened his calendar. Display boxes 406 and 408 are displayed in response to the invitation. In other words, the user will be prompted to take action on all calendar entries regardless of when they occur and regardless of whether the users' calendar is open at the time the invitation is accepted. The reception of the meeting by the calendaring system (e.g. automatic acceptance upon receiving the invitation or scheduling based on initiating a meeting) prompts two dialog boxes 406 and 408 to be displayed. The first dialog box 406 allows Bob to enter a time value associated with a time buffer he may desire before the scheduled meeting. Bob may use the scrolling time device 410 to enter the time value by moving the scrolling time up and down until the desired time value is selected. The software program receives a desired time value from the scrolling time device 410 and responds by placing a time value on the calendar in the desired time buffer. For example, if Bob needs 30 minutes to review calculations before the meeting, Bob may use the scrolling time device 410 to select 9:30-10:00. Bob may also type in “review calculations for meeting” in the text field provided 422. The desired time value (30 minutes) is displayed and Bob clicks on the “ok” button 418. The calendaring system will make an entry to Bob's calendar from 9:30-10:00 a.m. with the caption “review calculations for meeting” displayed in the calendar entry 404. The same process may be completed for dialog box 408. Alternatively, when Bob turns on his computer and opens his calendar program, he may have to manually open the invitation 404, at which time two dialog boxes 406 and 408 may be displayed. Bob may use the scrolling time value 410 to select the time buffer associated with a scheduling action. For example, Bob may wish to have a 30-minute time buffer before a meeting with Jim. When dialog box 406 is displayed Bob may use the scrolling time value 410 to select 8:30-9:00 a.m. As a result of this selection, Bob will have 30-minutes allotted as a time buffer before the 9:00 meeting with Jim. In response to selecting a 30-minute buffer, 30-minutes is displayed in time field 412. Alternatively, the time 8:30-9:00 a.m. is displayed in time field 412. In addition, Bob may write a reason in text field 422 for the time buffer. For example, Bob may wish to have 30-minutes to “read the xyz report” prior to the meeting with Jim. Bob may write, “read the xyz report” in text field 422. Bob may click the “ok” button 418 to save the information. In response to saving the information, the information is added to Bobs calendar and displayed.

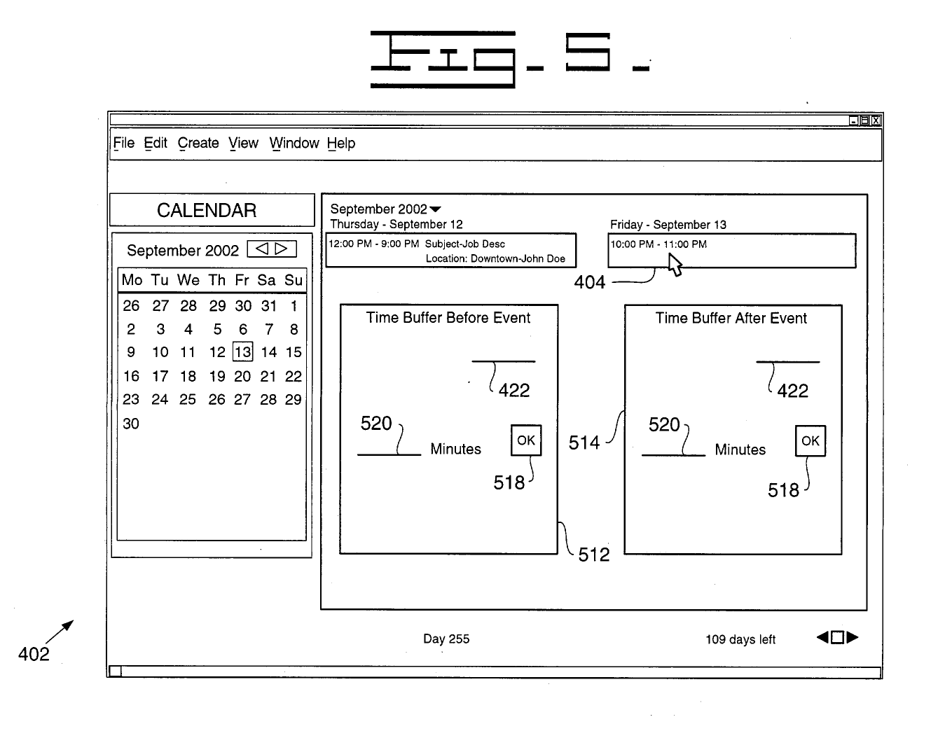

FIG. 5 is a screen shot illustrating one embodiment of a method of scheduling a time buffer associated with a calendar entry 404. In this embodiment, time buffer dialog boxes 512 and 514 are displayed in response to receiving, or initiating an invitation or other scheduling action. Bob enters a time value manually in the data entry portion 520 and clicks “ok” 518. Bob may write, “review calculations for meeting” in text field 422. The calendaring system will make an entry to Bob's calendar from 9:30-10:00 a.m. with the caption “review calculations for meeting” displayed in the calendar entry 404. The same process may be completed for dialog box 514. For example, Bob may wish to have a 45 minute time buffer after his meeting with Jim so Bob can make a phone call with someone and discuss the meeting. Bob would enter 45-minutes into time field 520 using his keyboard and click “ok” 518 to save the information. In response to saving the information, the information is added to Bobs calendar and displayed automatically by the calendaring program.

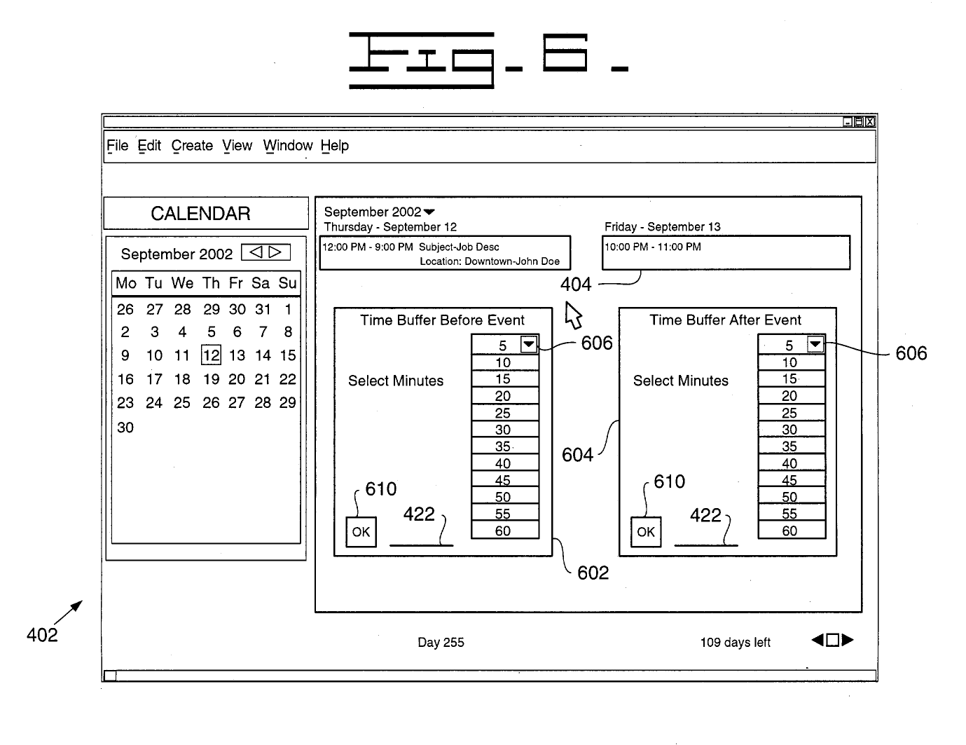

FIG. 6 is a screen shot illustrating one embodiment of a method of scheduling a time buffer associated with a calendar entry 404. In this embodiment, dialog boxes 602 and 604 are displayed in response to receiving, or initiating an invitation or other scheduling action. Bob uses the pull down button box 606 to select a time value (e.g. 30 minutes). The pull-down menu 506 may display numbers in uniform increments. (i.e. 5,10,15,20 etc. or 1,2,3,4,5,etc.). For example, Bob may wish to have a time buffer of 35 minutes before his meeting with Jim and a time buffer of 10 minutes after his meeting with Jim. In one embodiment, Bob can click on the invitation entry 404 on his calendar and two dialog boxes 602 and 604 will be displayed. Bob may select the number 35 from the pull-down menu 606 in dialog box 602 and Bob may select the number 10 from the pull-down menu 606 in dialog box 604. Bob may click “ok” 610 and the calendar program may save the information, add the information and display the entries on Bobs calendar 402. Bob may type in “review calculations for meeting” in text field 422. Bob may click “ok” 610. The calendaring system will make an entry to Bob's calendar from 9:30-10:00 a.m. with the caption “review calculations for meeting” displayed in the calendar entry 404. The same process may be completed for dialog box 604. If no time is desired, Bob may click “ok” 610 without entering any time value. The default time value may be zero and therefore no time buffer is scheduled.

Alternatively, Bob may have his calendar program open when the invitation from Jim is received. In this embodiment, two dialog boxes 602 and 604 may be displayed automatically, prompting Bob to enter a time buffer. Bob may not wish to enter any time in either of the two dialog boxes 602 and 604, in which case a default of zero would be entered. Alternatively, Bob may wish to enter a time value in one or both of the dialog boxes 602 and 604 in which case Bob would select a number from the pull-down menu 606, then click “ok” 610 to save the information, display the information and add it to his calendar.

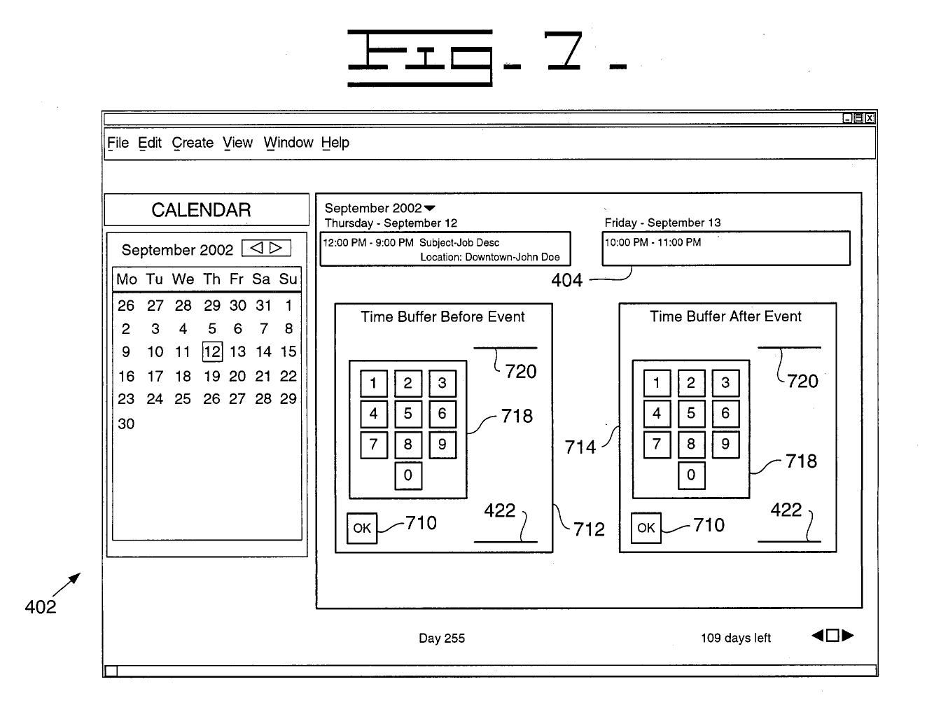

FIG. 7 is a screen shot illustrating one embodiment of a method of scheduling a time buffer associated with a calendar entry. In this embodiment, dialog boxes 712 and 714 are displayed in response to a sent invitation or other scheduling action. Bob uses keypad 718 to enter a time value (30 minutes). Bob may write, “review calculations for meeting” in text field 522. Bob may then click “ok” 710. The calendaring system will make an entry to Bob's calendar from 9:30-10:00 a.m. with the caption “review calculations for meeting” displayed in the calendar entry 504. The same process may be completed for dialog box 714. If not time is desired, Bob may click “ok” 710 without entering any time value and no time buffer is scheduled.

Other aspects, objects and advantages of this invention can be obtained from a study of the drawings, the disclosure and the appended claims.

What is claimed is:

1. A method of scheduling at least one time buffer associated with a calendar entry for at least one user in a networked environment comprising:
displaying at least one dialog box in response to a scheduling action;
prompting said user to enter a time value associated with at least one of said time buffer;
entering said time value into said at least one time buffer;
and, updating said users calendar with at least one entry in response to said scheduled time buffer.

2. A method, as set forth in claim 1, further comprising prompting said user by audio to enter said time value.

3. A method, as set forth in claim 1, further comprising the step of providing a recommended time value to said user.

4. A method, as set forth in claim 1, further comprising, entering said time value using a scrolling time device interface.

5. A method, as set forth in claim 1, further comprising, entering said time value manually.

6. A method, as set forth in claim 1, further comprising, utilizing a pull down button box to enter said time value.

7. A method, as set forth in claim 1, further comprising, utilizing a keypad to enter said time value.

8. A method of scheduling a time buffer associated with a calendar entry for at least one user in a networked environment comprising:
displaying a dialog box associated with a previously scheduled action.

9. A computer program product for scheduling at least one time buffer associated with a calendar entry for at least one user in a networked environment comprising:
a first computer readable program means for displaying at least one dialogue box in response to a scheduling action, said dialog box prompting said user to enter a time value associated with at least one of said time buffer;
a second computer readable program means for receiving said time value from said user; and
a third computer readable program means for updating said user's calendar in response to said received time value.
